(19) United States
(12) Patent Application Publication
(10) Pub. No.: US 2026/0360166 A1
(43) Pub. Date: Nov. 12, 2026

(54) ADAPTIVELY SELECTING VISUAL TOKENS

(71) Applicant: QUALCOMM Incorporated, San Diego, CA (US)

(72) Inventors: Jungsoo LEE, Paju (KR); Janghoon CHO, Seoul (KR); Sungha CHOI, Goyang-si (KR); Kyu Woong HWANG, Daejeon (KR)

(21) Appl. No.: 19/204,332

(22) Filed: May 9, 2025

(51) Int. Cl. G06V 20/70; G06V 30/19

(52) U.S. Cl. CPC G06V 20/70; G06V 30/19093

(57) ABSTRACT

Systems and techniques are described for processing data. For instance, a method for processing data is provided. The method may include processing video data to generate a first plurality of visual tokens; processing the first plurality of visual tokens to generate a first text, wherein the first text is descriptive of the video data; processing a frame of the video data to generate a second plurality of visual tokens; processing the second plurality of visual tokens to generate a second text, wherein the second text is descriptive of the frame of the video data; determining to process zero or more visual tokens selected from among the second plurality of visual tokens based on a similarity between the first text and the second text; and processing the first plurality of visual tokens and zero or more visual tokens selected from among the second plurality of visual tokens using a machine-learning model.

### TECHNICAL FIELD

The present disclosure generally relates to visual tokens. For example, aspects of the present disclosure include systems and techniques for adaptively selecting visual tokens, for example, for processing by a large multimodal model.

### BACKGROUND

Large Multimodal Models (LMMs) and/or Vision-Language Models (VLMs) may generate text based on text prompts (e.g., from a user) and input visual frames (e.g., individual images and/or frames of video data). Since each image may result in multiple visual tokens (e.g., hundreds, thousands, or more), utilizing multiple images (e.g., multiple frames of video data) may involve a non-trivial number of visual tokens (e.g., millions or more). The number of visual tokens of a number of frames of video data may cause a performance bottleneck.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing data. According to at least one example, a method is provided for processing data. The method includes: processing video data to generate a first plurality of visual tokens; processing the first plurality of visual tokens to generate a first text, wherein the first text is descriptive of the video data; processing a frame of the video data to generate a second plurality of visual tokens; processing the second plurality of visual tokens to generate a second text, wherein the second text is descriptive of the frame of the video data; determining to process zero or more visual tokens selected from among the second plurality of visual tokens based on a similarity between the first text and the second text; and processing the first plurality of visual tokens and zero or more visual tokens selected from among the second plurality of visual tokens using a machine-learning model.

In another example, an apparatus for processing data is provided that includes at least one memory and at least one processor (e.g., configured in circuitry) coupled to the at least one memory. The at least one processor configured to: process video data to generate a first plurality of visual tokens; process the first plurality of visual tokens to generate a first text, wherein the first text is descriptive of the video data; process a frame of the video data to generate a second plurality of visual tokens; process the second plurality of visual tokens to generate a second text, wherein the second text is descriptive of the frame of the video data; determine to process zero or more visual tokens selected from among the second plurality of visual tokens based on a similarity between the first text and the second text; and process the first plurality of visual tokens and zero or more visual tokens selected from among the second plurality of visual tokens using a machine-learning model.

In another example, a non-transitory computer-readable medium is provided that has stored thereon instructions that, when executed by one or more processors, cause the one or more processors to: process video data to generate a first plurality of visual tokens; process the first plurality of visual tokens to generate a first text, wherein the first text is descriptive of the video data; process a frame of the video data to generate a second plurality of visual tokens; process the second plurality of visual tokens to generate a second text, wherein the second text is descriptive of the frame of the video data; determine to process zero or more visual tokens selected from among the second plurality of visual tokens based on a similarity between the first text and the second text; and process the first plurality of visual tokens and zero or more visual tokens selected from among the second plurality of visual tokens using a machine-learning model.

In another example, an apparatus for processing data is provided. The apparatus includes: means for processing video data to generate a first plurality of visual tokens; means for processing the first plurality of visual tokens to generate a first text, wherein the first text is descriptive of the video data; means for processing a frame of the video data to generate a second plurality of visual tokens; means for processing the second plurality of visual tokens to generate a second text, wherein the second text is descriptive of the frame of the video data; means for determining to process zero or more visual tokens selected from among the second plurality of visual tokens based on a similarity between the first text and the second text; and means for processing the first plurality of visual tokens and zero or more visual tokens selected from among the second plurality of visual tokens using a machine-learning model.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system for generating visual tokens based on video data, according to various aspects of the present disclosure;

FIG. 2 includes a representation of example video data and a representation of example frames of the video data;

FIG. 3 is a block diagram illustrating an example system for generating and selecting visual tokens based on video data, according to various aspects of the present disclosure;

FIG. 4 is a flow diagram illustrating an example process for generating and selecting visual tokens, in accordance with aspects of the present disclosure;

FIG. 5 is a block diagram illustrating an example of a deep learning neural network that can be used to perform various tasks, according to some aspects of the disclosed technology;

FIG. 6 is a block diagram illustrating an example of a convolutional neural network (CNN), according to various aspects of the present disclosure;

FIG. 7 is a block diagram illustrating a multimodal generative machine-learning system for generating natural language responses based on natural language input from a prompt and any additional information;

FIG. 8 includes an example machine-learning model that may be used in various aspects of the present disclosure;

FIG. 9 is a block diagram of an example transformer in accordance with some aspects of the disclosure; and

FIG. 10 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted above, Large Multimodal Models (LMMs) and/or Vision-Language Models (VLMs) may generate text based on text prompts (e.g., from a user) and input visual frames (e.g., individual images and/or frames of video data). Since each image may result in multiple visual tokens (e.g., hundreds, thousands, or more), utilizing multiple images (e.g., multiple frames of video data) may involve a non-trivial number of visual tokens (e.g., millions or more). The number of visual tokens of a number of frames of video data may cause a performance bottleneck.

One approach to reducing the number of visual tokens for processing video data involves selecting a predetermined number of visual tokens from each image frame of the video data and/or a predetermined number of image frames of the video data. The approach further involves pretraining LMMs with the predetermined number of visual tokens. For example, a user may select a number of visual tokens from among the number of available visual tokens, for instance, {1, 9, 36, 144, 576}. Additionally, the user may select a number of frames of the video data. An LMM may be trained using the selected number of visual tokens (e.g., the predetermined number of tokens from each of the predetermined number of frames). During the inference phase (e.g., using the trained LMM at inference), only the predefined number of visual tokens is processed.

Another approach top reducing the number of visual tokens involves merging tokens after each layer of an image encoder. Such an approach still relies on selecting a predetermined number of visual tokens to merge.

One downside of such approaches is that a number of visual tokens has to be predetermined. Such approaches fail to systemically adjust the number of visual tokens depending on the visual information.

For example, if several frames of video data are substantially the same, visual tokens from multiple ones of the several frames may be redundant. However, conventional approaches may cause a LMM to process the same number of visual tokens from each of the several frames.

Systems, apparatuses, methods (also referred to as processes), and computer-readable media (collectively referred to herein as “systems and techniques”) are described herein for adaptively selecting visual tokens for processing (e.g., at an LMM). For example, the systems and techniques described herein may determine a number of visual tokens to process from each input image based on visual information conveyed by the input images.

For example, the systems and techniques may utilize an adaptive number of visual tokens depending on visual information of the images from which the visual tokens are extracted. For instance, the systems and techniques may determine a number of visual tokens to use from a given image based on the visual information of the image. The systems and techniques may not rely on a predetermined numbers of visual tokens. Rather, the systems and techniques determine the number of visual tokens per input image.

The systems and techniques may use two captioning models for evaluating the importance of visual information of each input image. For example, a video-captioning model may generate a caption for a window of input images (e.g., 30 seconds' worth of image frames). Additionally, an image-captioning model may generate a caption for each image frame of the video data. Alternatively, the image-capturing model may generate a caption for a subset of the image frames. For example, the image-captioning model may generate a capture for one image frame of each second of the video data.

The systems and techniques may determine meaningful image frames versus redundant image frames. For example, the systems and techniques may use perplexity to measure distances between a caption of the video data and captions of one or more respective frames of the video data. The systems and techniques may distinguish meaningful image frames from redundant image frames by thresholding a dissimilarity (e.g., distance) of the captions. For example, an image frame that has a caption that is substantially the same as (e.g., within a threshold) the caption of the video data may be determined to be redundant. Alternatively, an image frame that has a caption that is substantially different from (e.g., outside a threshold) the caption of the video data may be determined to be meaningful.

The systems and techniques may select visual tokens from meaningful frames (e.g., frames with captions that are different from a caption of the video data) to be processed by an LMM. The systems and techniques may not select visual tokens from redundant frames (e.g., frames with captions that are substantially similar to a caption of the video data) to be processed by the LMM.

After selecting frames to process, the systems and techniques may determine a number of visual tokens to process from each of the selected frames. The systems and techniques may select the number of visual tokens for each selected frame based on distances between the captions of the video data and the captions of the selected frames. The systems and techniques may use perplexity to measure the similarity or difference between captions. The systems and techniques may select more visual tokens from image frames with captions that are more dissimilar to the caption of the video data. Further, the systems and techniques may select fewer visual tokens from image frames with captions that are more similar to the caption of the video data.

An advantage of using text captions to compare images with video data (e.g., to select frames and/or to select a number of visual tokens) is that semantically comparing the images and video data (e.g., by comparing the captions) may provide particularly relevant results for downstream tasks, such as semantic question-and-answer tasks that may be common use cases for LMMs. Comparing text embeddings can be a useful approach for filtering visual tokens for semantic tasks.

An alternative approach to comparing video data to image data would be to compare visual tokens directly (e.g., using a geometric distance, such as a cosine distance). Comparing visual tokens may result in selecting visually diverse frames. Visually diverse frames may, or may not, be pertinent to semantic meanings of the frames.

In the present disclosure, the terms “image,” “frame,” “image frame,” “image data,” “frame data,” and like terms may refer to image data including values (e.g., color and/or intensity values) for a number of pixels. Unless otherwise specified, the terms “image,” “frame,” “image data,” and “frame data,” may refer to a single image or frame. Additionally, the terms “image,” “frame,” “image frame,” “image data,” “frame data,” and like terms may include, (or include an association between pixel data and) metadata, such as time-stamps, audio data, etc.

In contrast, the terms “video data,” “video,” and like terms may refer to data including multiple images or frames. The images or frames of video data may be arranged sequentially and/or have times associated with them. For example, an example instance of video data may include 900 frames, for instance, 30 seconds' worth of frames captured at a rate of 30 frames per second (fps) and/or meant to be displayed at the rate of 30 fps. Additionally, the terms “video data,” “video,” and like terms may include (or include an association with) audio data and/or metadata, such as timestamps, etc.

In the present disclosure, the terms “visual tokens,” “image features,” “image embeddings,” and like terms may refer to outputs of an encoder machine-learning model. For example, an encoder (e.g., of a convolutional neural network (CNN)) may extract visual tokens from an image. In other words, the encoder may encode or process the image to generate the visual tokens.

In the present disclosure, examples are provided with regard to LMMs and LVMs. The systems and techniques are not limited to uses with LMMs and LVMs. The systems and techniques may apply to any task in which visual tokens are selected for a downstream tasks in which semantics may be important. Such tasks include image summarization, video summarization, answering questions about images, answering questions about video, etc.

Various aspects of the application will be described with respect to the figures below.

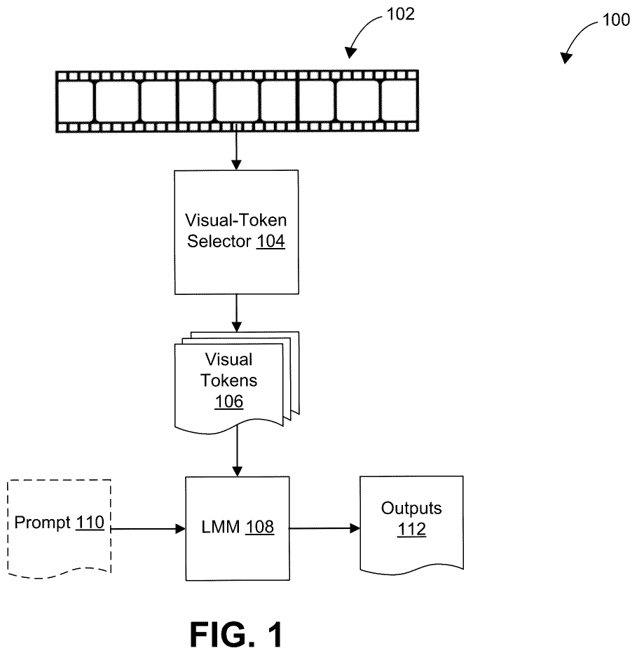

FIG. 1 is a block diagram illustrating an example system 100 for generating visual tokens 106 based on video data 102, according to various aspects of the present disclosure. Video data 102 may be, or may include, video data including any number of frames.

Visual-token selector 104 may generate visual tokens based on video data 102 (e.g., as a whole or in clips). Additionally, video data 102 may generate visual tokens based on individual frames of video data 102. Video data 102 may generate a video caption based on the visual tokens based on video data 102 as a whole (or in clips). Additionally video data 102 may generate image captions based on visual tokens based on individual frames. Video data 102 may compare the image captions to the video caption to select frames of video data 102 to from which to use visual tokens. Additionally, based on the comparison, video data 102 may determine how many visual tokens to use from each of the selected frames. Visual-token selector 104 may select visual tokens 106 from among the visual tokens based on video data 102 and the visual tokens based on individual frames of video data 102 based on the comparison of the video caption to the image captions.

LMM 108 may be, or may include, a machine-learning model, for example, a large multimodal model or a language vision model. LMM 108 may be trained to generate outputs based on visual tokens based on image data and/or video data.

In some aspects, a projector may project visual tokens 106 based on an embedding space of LMM 108. For example, visual tokens 106 may be, or may include, a number of multidimensional vectors in an embedding space that is based on an encoder that encoded visual tokens 106. The projector may modify the embedding space according to an embedding space of LMM 108.

LMM 108 may generate outputs 112 based on visual tokens 106. In some aspects, LMM 108 may also generate outputs 112 based on prompt 110 (e.g., a prompt from a user). LMM 108 may perform any number of tasks, such as image or video description of summarization, question answering, etc. As such, outputs 112 may be a textual response to prompt 110, a textual description of video data 102, etc.

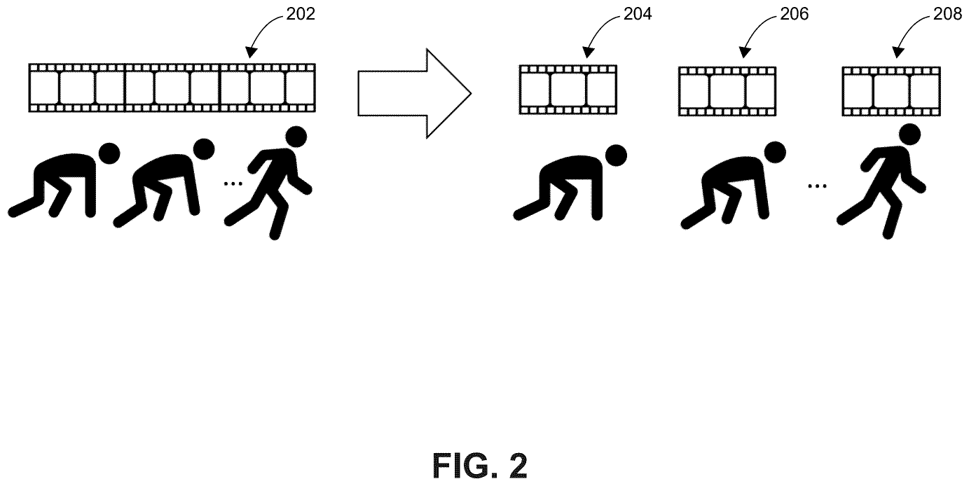

FIG. 2 includes a representation of example video data 202 and a representation of an example frame 204, an example frame 206, and an example frame 208, all of video data 202. Video data 202 may include video data including any number of frames. In some aspects, a system (e.g., system 100) may segment larger video data into clips (e.g., including video data 202). For example, video data 202 may be an example clip of a predetermined size (e.g., 30 seconds' worth of video data) selected from larger video data.

Video data 202 may include any number of frames. An example frame 204 of video data 202 may a representation of a person crouching. Another example frame 206 of video data 202 may include a representation of the person crouching, for example, in a slightly different pose. Yet another example frame 208 may include a representation of the person running.

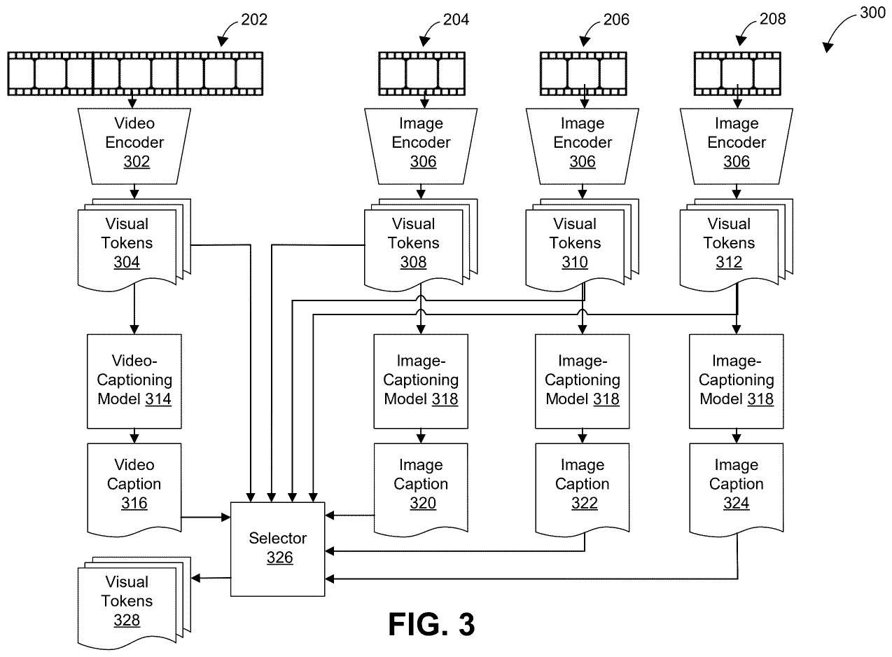

FIG. 3 is a block diagram illustrating an example system 300 for generating and selecting visual tokens based on video data, according to various aspects of the present disclosure. Visual-token selector 104 of FIG. 1 may implement or include system 300.

System 300 may segment video data 202 into frames. Frame 204, frame 206, and frame 208 are example frames of video data 202. In some aspects, system 300 may individually process each frame of video data 202 (e.g., as described with regard to the processing of any one of frame 204, frame 206 and frame 208). In other aspects, system 300 may process a subset of frames of video data 202. For example, system 300 may select a predetermined number of frames from among the frames of video data 202. For instance, system 300 may select every tenth frame, or every 30th frame of video data 202 for processing.

Video encoder 302 may process video data 202 to generate visual tokens 304. Video encoder 302 may be, or may include, an encoder machine-learning model trained to generate visual tokens based on video data. In some aspects, video encoder 302 may encode a number of frames of video data 202 such that visual tokens 304 includes a number of visual tokens from a number of respective frames of video data 202. Visual tokens 304 may include a number of separable or distinct visual tokens. Visual tokens 304 may be a multi-dimensional tensor of numbers. Visual tokens 304 may be mapped to an n-dimensional space as a vector.

Similarly, image encoder 306 may generate visual tokens 308 based on image encoder 306. Image encoder 306 may be, or may include, an encoder machine-learning model trained to generate visual tokens based on image data. Visual tokens 308 may be a multi-dimensional tensor of numbers. Visual tokens 308 may include a number of separable or distinct visual tokens. Visual tokens 308 may be mapped to an n-dimensional space as a vector. Visual tokens 310 may be substantially similar to visual tokens 308, except that whereas visual tokens 308 are based on frame 204, visual tokens 310 are based on frame 206. Similarly, visual tokens 312 may be substantially similar to visual tokens 308, except that whereas visual tokens 308 are based on frame 204, visual tokens 312 are based on frame 208.

System 300 may include any number of instances of image encoder 306. For example, system 300 may include multiple instances of image encoder 306. System 300 may use each of the instances to process a respective frame of video data 202 to generate a respective set of visual tokens. Additionally or alternatively, system 300 may use an instance of image encoder 306 to process multiple frames sequentially. In any case, image encoder 306 may process frame 204 to generate visual tokens 308, process frame 206 to generate visual tokens 310, and process frame 208 to generate visual tokens 312.

Video-captioning model 314 may generate video caption 316 based on visual tokens 304. Video caption 316 may be, or may include, text. Video caption 316 may describe video data 202. Video-captioning model 314 may convert visual tokens 304 into text (e.g., video caption 316). Video-captioning model 314 may be, or may include, a machine-learning model trained to generate text based on visual tokens that are based on video data.

Similarly, image-captioning model 318 may generate image caption 320 based on visual tokens 308. Image caption 320 may be, or may include, text. Image caption 320 may describe frame 204. Image-captioning model 318 may convert visual tokens 304 into text (e.g., image caption 320). Image-captioning model 318 may be, or may include, a machine-learning model trained to generate text based on visual tokens that are based on image data.

System 300 may include any number of instances of image-captioning model 318. For example, system 300 may include multiple instances of image-captioning model 318. System 300 may use each of the instances to process a respective set of visual tokens based on a respective frame of video data 202 to generate a respective caption. Additionally or alternatively, system 300 may use an instance of image-captioning model 318 to process multiple sets of visual tokens sequentially. In any case, image-captioning model 318 may process visual tokens 308 to generate image caption 320, process visual tokens 310 to generate image caption 322, and process visual tokens 312 to generate image caption 324.

Selector 326 may select visual tokens 328 from among visual tokens 304, visual tokens 308, visual tokens 310, and visual tokens 312 based on video caption 316, image caption 320, image caption 322, and image caption 324. System 300 may output the visual tokens 328 (e.g., as visual tokens 106).

Selector 326 may select frames of video data 202 from which to select visual tokens (e.g., based on a similarity between video caption 316 and the image captions of the frames). Additionally or alternatively, selector 326 may select a number of visual tokens to select from each of the selected frames (e.g., based on a similarity between video caption 316 and the image captions of the selected frames).

For example, selector 326 may compare the image captions of each of the frames to video caption 316 to determine from which frames to select visual tokens. Selector 326 may select the frames having captions that are dissimilar to video caption 316.

For example, selector 326 may perform a perplexity-based comparison between video caption 316 and each of the image captions. Perplexity may measure an uncertainty of generated texts. For example, given a first three words of a first text, perplexity may be a likelihood of predicting the fourth word of a second text. The higher the perplexity is, the more uncertain text generator is when generating a single token. If perplexity is 1, the model predicts the next word perfectly. A perplexity calculation may be, or may include:

PPL=exp(H(p,q))
where H represents an entropy loss,
where p represents a predicted token, and
where q represents a ground truth token.

Selector 326 may use image captions as predicted tokens and video captions as ground truth tokens. A small perplexity indicates that a given image and the video convey similar information (e.g., based on the similarity of the caption of the given image and the video caption). On the other hand, a high perplexity indicates that a given image and the video convey non-overlapping information (e.g., based on the dissimilarity of the caption of the given image and the video caption). For visual tokens 328 to convey information regarding all of video data 202, it may be important to select visual tokens from video data 202 and visual tokens from frames conveying information that is dissimilar to the information represented by the visual tokens of the video data.

For example, video caption 316 (which is based on and may describe video data 202) may be, or may include, “a man rises from a crouch.” Image caption 320 (which is based on and may describe frame 204 of video data 202) may be, or may include, “a man is crouching.” Image caption 322 (which is based on and may describe frame 206 of video data 202) may be, or may include, “a man is crouching.” Image caption 324 (which is based on and may describe frame 208 of video data 202) may be, or may include, “a man is running.”

Selector 326 may determine a perplexity of 0.4 between video caption 316 (e.g., “a man stands from a crouch”) and image caption 320 (e.g., “a man is crouching”). Similarly, selector 326 may determine a perplexity of 0.4 between video caption 316 (e.g., “a man stands from a crouch”) and image caption 322 (e.g., “a man is crouching”). Selector 326 may determine a perplexity of 2.4 between video caption 316 (e.g., “a man stands from a crouch”) and image caption 324 (e.g., “a man is running”).

Based on the relatively low perplexity of image caption 320 relative to video caption 316, selector 326 may determine to not include visual tokens from visual tokens 310 in visual tokens 328. For example, video tokens selected from visual tokens 308 may be redundant with video tokens selected from visual tokens 304. Similarly, based on the relatively low perplexity of image caption 322 relative to video caption 316, selector 326 may determine to not include visual tokens from visual tokens 308 in visual tokens 328. Based on the relatively high perplexity of image caption 324 relative to video caption 316, selector 326 may determine to include visual tokens from visual tokens 312 in visual tokens 328. For example, visual tokens 312 may include visual tokens that convey novel information relative to the information conveyed by video caption 316.

Additionally or alternatively, selector 326 may determine a number of visual tokens to select from frames based on the similarity of the captions of the frames to video caption 316. For example, there may be a perplexity of 0.4 between video caption 316 and image caption 320, there may be a perplexity of 0.4 between video caption 316 and image caption 322, and there may be a perplexity of 2.4 between video caption 316 and image caption 324. If selector 326 has not already determined to not select visual tokens based on frame 204 (e.g., as described above), selector 326 may determine to select fewer visual tokens from among visual tokens 308 than from among visual tokens 312 based on the perplexity of image caption 324 relative to video caption 316 being higher than a perplexity of image caption 320 relative to video caption 316. For instance, if selector 326 has not already determined to not select visual tokens based on frame 204 (e.g., as described above), selector 326 may determine to select visual tokens from among visual tokens 308 and visual tokens 312 based on a relationship between the perplexities of video encoder 302 and image caption 324 relative to video caption 316. For example, selector 326 may determine to select six times more visual tokens from among visual tokens 312 than from among visual tokens 308 based on the perplexity of image caption 324 relative to video caption 316 being six times greater than the perplexity of image caption 320 relative to video caption 316.

In some cases, selector 326 may determine to select zero visual tokens from among the tokens of a frame based on the perplexity between a caption of the frame and video caption 316 and/or the perplexity between the captions of other frames and video caption 316. For example, whether or not selector 326 determined to select visual tokens based on frame 204, selector 326 may determine to not select visual tokens from among visual tokens 308 based on the perplexity of image caption 320 relative to video caption 316 being lower than a threshold (e.g., below 1.0) and/or based on the perplexity of image caption 320 relative to video caption 316 being a threshold factor (e.g., five times) less than the perplexity of image caption 324 relative to video caption 316.

In cases in which selector 326 has determined to select visual tokens from among visual tokens 312 and not from among visual tokens 308 (e.g., as described above), selector 326 may determine the number of visual tokens to select from among visual tokens 312 based on the perplexity of image caption 324 relative to video caption 316. For example, based on the perplexity of image caption 324 relative to video caption 316 being 2.4, selector 326 may determine to select 24% (e.g., 2.4/10.0) or 48% (e.g., 2.4/5.0) or some other percentage of visual tokens 312. As another example, selector 326 may determine to select a percentage of a total budget of visual tokens 328 from among visual tokens 312 based on the perplexity of image caption 324 relative to video caption 316.

Additionally, in some aspects, selector 326 may determine a number of visual tokens to select from among visual tokens 304. For example, in some aspects, selector 326 may select a fraction (e.g., one quarter, one half, three quarters) of visual tokens 304.

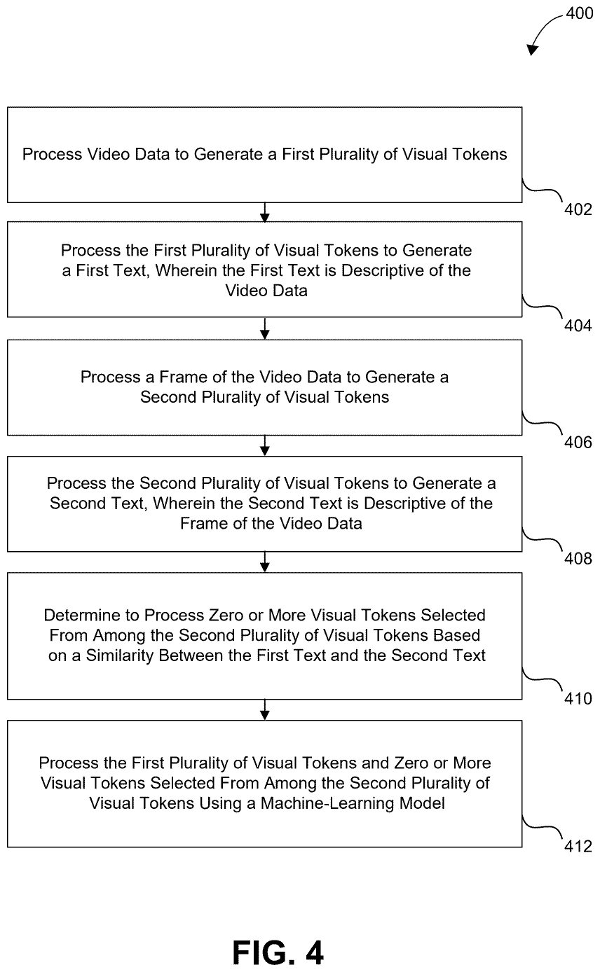

FIG. 4 is a flow diagram illustrating an example process 400 for generating and selecting visual tokens, in accordance with aspects of the present disclosure. One or more operations of process 400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 400. The one or more operations of process 400 may be implemented as software components that are executed and run on one or more processors.

At block 402, a computing device (or one or more components thereof) may process video data to generate a first plurality of visual tokens. For example, video encoder 302 may process video data 202 to generate visual tokens 304.

At block 404, the computing device (or one or more components thereof) may process the first plurality of visual tokens to generate a first text, wherein the first text is descriptive of the video data. For example, video-captioning model 314 may process visual tokens 304 to generate video-captioning model 314. Video-captioning model 314 may describe of video data 202.

At block 406, the computing device (or one or more components thereof) may process a frame of the video data to generate a second plurality of visual tokens. For example, image encoder 306 may process frame 204 to generate visual tokens 308.

In some aspects, to process the video data to generate the first plurality of visual tokens, the computing device (or one or more components thereof) may process the video data using a video-encoder machine-learning model to generate the first plurality of visual tokens; and to process the frame of the video data to generate the second plurality of visual tokens, the computing device (or one or more components thereof) may process the frame of the video data using an image-encoder machine-learning model to generate the second plurality of visual tokens. For example, video encoder 302 (which may be, or may include, a machine-learning model trained to encode video data) may process video data 202 to generate visual tokens 304. For example, image encoder 306 (which may be, or may include, a machine-learning model trained to encode image data) may process frame 204 to generate visual tokens 308.

At block 408, the computing device (or one or more components thereof) may process the second plurality of visual tokens to generate a second text, wherein the second text is descriptive of the frame of the video data. For example, image-captioning model 318 may process visual tokens 308 to generate image caption 320. Image caption 320 may describe frame 204.

In some aspects, to process the first plurality of visual tokens to generate the first text, the computing device (or one or more components thereof) may process the first plurality of visual tokens to using a video-captioning model to generate the first text; and to process the second plurality of visual tokens to generate the second text, the computing device (or one or more components thereof) may process the second plurality of visual tokens to using an image-captioning model to generate the second text. For example, video-captioning model 314 (which may be, or may include, a machine-learning model trained to generate descriptions of video) may process visual tokens 304 to generate video-captioning model 314. For example, image-captioning model 318 (which may be, or may include, a machine-learning model trained to generate descriptions of images) may process visual tokens 308 to generate image caption 320.

At block 410, the computing device (or one or more components thereof) may determine to process zero or more visual tokens selected from among the second plurality of visual tokens based on a similarity between the first text and the second text. For example, selector 326 may determine to process zero or more visual tokens selected from among visual tokens 308 based on a similarity between video caption 316 and image caption 320.

In some aspects, the computing device (or one or more components thereof) may select the zero or more visual tokens from among the second plurality of visual tokens based on a similarity between the first text and the second text. For example, selector 326 may select zero of more of visual tokens 308 to process based on the similarity between video caption 316 and image caption 320. For instance, selector 326 may select zero or more of visual tokens 308 to include in visual tokens 328 based on the similarity between video caption 316 and image caption 320.

In some aspects, the similarity between the first text and the second text may be, or may include, a perplexity score based on the first text and the second text. For example, selector 326 may determine a perplexity score between video caption 316 and image caption 320 and select zero or more of visual tokens 308 to process based on the perplexity score.

In some aspects, in response to the similarity between the first text and the second text not exceeding a threshold, the computing device (or one or more components thereof) may process the first plurality of visual tokens and zero visual tokens from among the second plurality of visual tokens using the machine-learning model. For example, based on the similarity between video caption 316 and image caption 320 not exceeding a threshold, selector 326 may determine to process zero tokens from among visual tokens 308.

At block 412, the computing device (or one or more components thereof) may process the first plurality of visual tokens and zero or more visual tokens selected from among the second plurality of visual tokens using a machine-learning model. For example, LMM 108 may process visual tokens 328 (which may include visual tokens 304 and zero or more of visual tokens 308 as selected by selector 326).

In some aspects, the machine-learning model may be, or may include, a large multi-modal model configured to generate an output based on visual tokens. For example, LMM 108 may process visual tokens 328 to generate outputs 112.

In some aspects, the frame of the video data may be a first frame of the video data. The computing device (or one or more components thereof) may may process a second frame of the video data to generate a third plurality of visual tokens; process the third plurality of visual tokens to generate a third text; and determine to process zero or more visual tokens selected from among the third plurality of visual tokens based on a similarity between the first text and the third text, To process the first plurality of visual tokens and zero or more visual tokens selected from among the second plurality of visual tokens using the machine-learning model, the computing device (or one or more components thereof) may may process the first plurality of visual tokens, zero or more visual tokens selected from among the second plurality of visual tokens, and zero or more visual tokens selected from among the third plurality of visual tokens using the machine-learning model. For example, image encoder 306 may process frame 206 to generate visual tokens 310. Image-captioning model 318 may process image encoder 306 to generate image caption 322. Selector 326 may determine to process zero or more tokens selected from among visual tokens 310 based on a similarity between video caption 316 and image caption 322. Selector 326 may select zero of more of visual tokens 310 to include in visual tokens 328 based on the similarity between video caption 316 and image caption 322. LMM 108 may process visual tokens 328 (which may include visual tokens 304, zero or more of visual tokens 308 as selected by selector 326, and zero or more of visual tokens 310 as selected by selector 326).

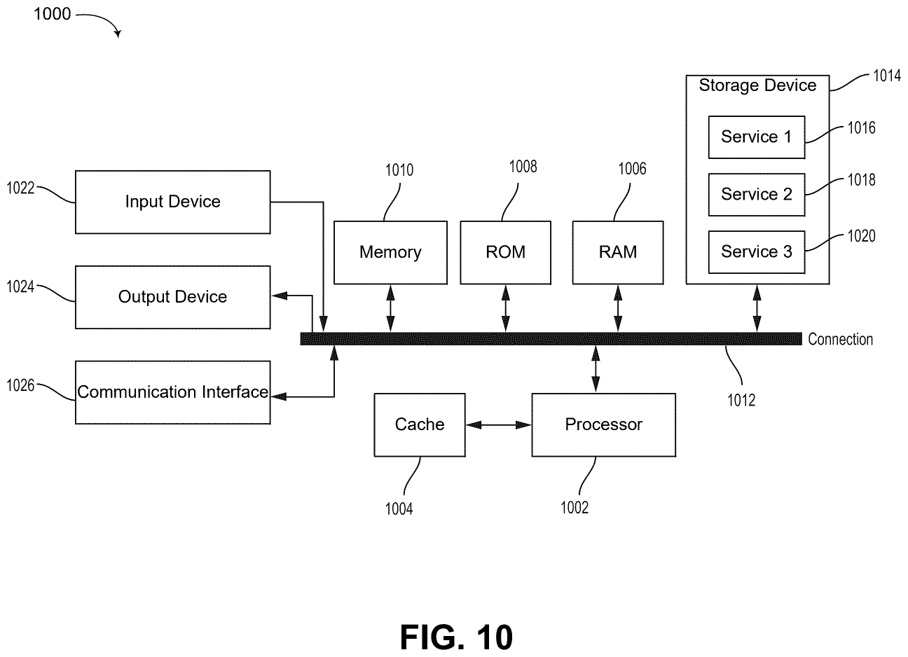

In some examples, as noted previously, the methods described herein (e.g., process 400 of FIG. 4, and/or other methods described herein) can be performed, in whole or in part, by a computing device or apparatus. In one example, one or more of the methods can be performed by system 100 of FIG. 1, visual-token selector 104 of FIG. 1, system 300 of FIG. 3, or by another system or device. In another example, one or more of the methods (e.g., process 400, and/or other methods described herein) can be performed, in whole or in part, by the computing-device architecture 1000 shown in FIG. 10. For instance, a computing device with the computing-device architecture 1000 shown in FIG. 10 can include, or be included in, the components of the system 100, visual-token selector 104, system 300, and can implement the operations of process 400, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 400, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 400, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

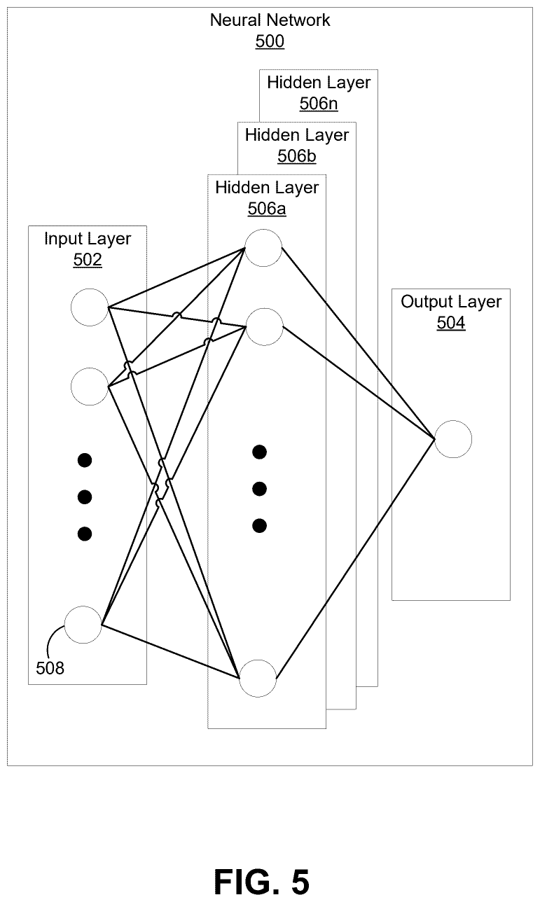

FIG. 5 is an illustrative example of a neural network 500 (e.g., a deep-learning neural network) that can be used to implement machine-learning based feature extraction, image encoding, video encoding, image captioning, video captioning, feature segmentation, implicit-neural-representation generation, rendering, classification, object detection, image recognition (e.g., face recognition, object recognition, scene recognition, etc.), authentication, gaze detection, gaze prediction, and/or automation. For example, neural network 500 may be an example of, or can implement, video encoder 302, image encoder 306, video-captioning model 314, and/or image-captioning model 318.

An input layer 502 includes input data. In one illustrative example, input layer 502 can include data such as text data, numerical data, image data, audio data, video data, etc. Neural network 500 includes multiple hidden layers, for example, hidden layers 506a, 506b, through 506n. The hidden layers 506a, 506b, through hidden layer 506n include “n” number of hidden layers, where “n” is an integer greater than or equal to one. The number of hidden layers can be made to include as many layers as needed for the given application. Neural network 500 further includes an output layer 504 that provides an output resulting from the processing performed by the hidden layers 506a, 506b, through 506n. In one illustrative example, output layer 504 can output data such as text data, numerical data, image data, audio data, video data, etc.

Neural network 500 may be, or may include, a multi-layer neural network of interconnected nodes. Each node can represent a piece of information. Information associated with the nodes is shared among the different layers and each layer retains information as information is processed. In some cases, neural network 500 can include a feed-forward network, in which case there are no feedback connections where outputs of the network are fed back into itself. In some cases, neural network 500 can include a recurrent neural network, which can have loops that allow information to be carried across nodes while reading in input.

Information can be exchanged between nodes through node-to-node interconnections between the various layers. Nodes of input layer 502 can activate a set of nodes in the first hidden layer 506a. For example, as shown, each of the input nodes of input layer 502 is connected to each of the nodes of the first hidden layer 506a. The nodes of first hidden layer 506a can transform the information of each input node by applying activation functions to the input node information. The information derived from the transformation can then be passed to and can activate the nodes of the next hidden layer 506b, which can perform their own designated functions. Example functions include convolutional, up-sampling, data transformation, and/or any other suitable functions. The output of the hidden layer 506b can then activate nodes of the next hidden layer, and so on. The output of the last hidden layer 506n can activate one or more nodes of the output layer 504, at which an output is provided. In some cases, while nodes (e.g., node 508) in neural network 500 are shown as having multiple output lines, a node has a single output and all lines shown as being output from a node represent the same output value.

In some cases, each node or interconnection between nodes can have a weight that is a set of parameters derived from the training of neural network 500. Once neural network 500 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 500 to be adaptive to inputs and able to learn as more and more data is processed.

Neural network 500 may be pre-trained to process the features from the data in the input layer 502 using the different hidden layers 506a, 506b, through 506n in order to provide the output through the output layer 504. In an example in which neural network 500 is used to identify features in images, neural network 500 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 500 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 500 is trained well enough so that the weights of the layers are accurately tuned.

For the example of identifying objects in images, the forward pass can include passing a training image through neural network 500. The weights are initially randomized before neural network 500 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 500, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 500 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 500 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 500 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 500 can include any other deep network other than a CNN, such as an autoencoder, a deep belief nets (DBNs), a Recurrent Neural Networks (RNNs), among others.

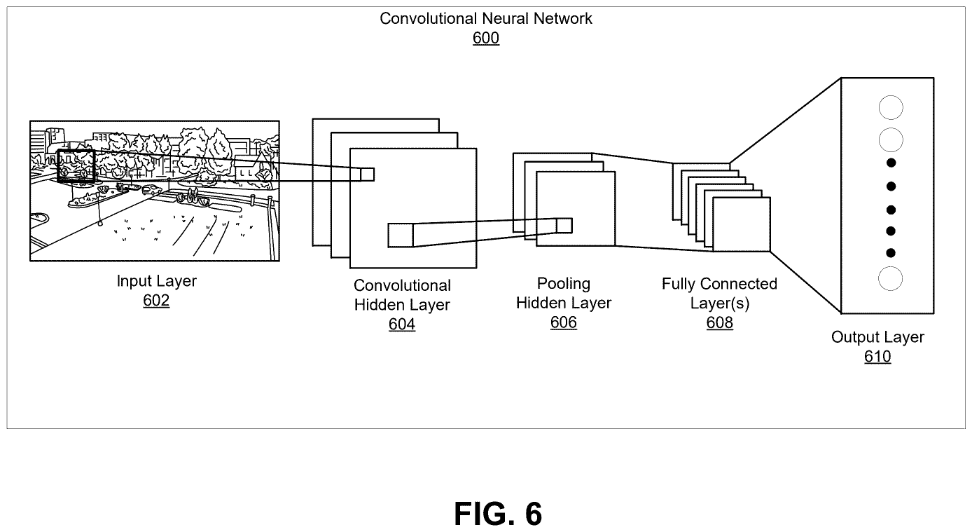

FIG. 6 is an illustrative example of a convolutional neural network (CNN) 600. The input layer 602 of the CNN 600 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 604, an optional non-linear activation layer, a pooling hidden layer 606, and fully connected layer 608 (which fully connected layer 608 can be hidden) to get an output at the output layer 610. While only one of each hidden layer is shown in FIG. 6, one of ordinary skill will appreciate that multiple convolutional hidden layers, non-linear layers, pooling hidden layers, and/or fully connected layers can be included in the CNN 600. As previously described, the output can indicate a single class of an object or can include a probability of classes that best describe the object in the image.

The first layer of the CNN 600 can be the convolutional hidden layer 604. The convolutional hidden layer 604 can analyze image data of the input layer 602. Each node of the convolutional hidden layer 604 is connected to a region of nodes (pixels) of the input image called a receptive field. The convolutional hidden layer 604 can be considered as one or more filters (each filter corresponding to a different activation or feature map), with each convolutional iteration of a filter being a node or neuron of the convolutional hidden layer 604. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 604. Each connection between a node and a receptive field for that node learns a weight and, in some cases, an overall bias such that each node learns to analyze its particular local receptive field in the input image. Each node of the convolutional hidden layer 604 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 604 is due to each node of the convolutional layer being applied to its corresponding receptive field. For example, a filter of the convolutional hidden layer 604 can begin in the top-left corner of the input image array and can convolve around the input image. As noted above, each convolutional iteration of the filter can be considered a node or neuron of the convolutional hidden layer 604. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 604. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 604.

The mapping from the input layer to the convolutional hidden layer 604 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 604 can include several activation maps in order to identify multiple features in an image. The example shown in FIG. 6 includes three activation maps. Using three activation maps, the convolutional hidden layer 604 can detect three different kinds of features, with each feature being detectable across the entire image.

In some examples, a non-linear hidden layer can be applied after the convolutional hidden layer 604. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 600 without affecting the receptive fields of the convolutional hidden layer 604.

The pooling hidden layer 606 can be applied after the convolutional hidden layer 604 (and after the non-linear hidden layer when used). The pooling hidden layer 606 is used to simplify the information in the output from the convolutional hidden layer 604. For example, the pooling hidden layer 606 can take each activation map output from the convolutional hidden layer 604 and generates a condensed activation map (or feature map) using a pooling function. Max-pooling is one example of a function performed by a pooling hidden layer. Other forms of pooling functions be used by the pooling hidden layer 606, such as average pooling, L2-norm pooling, or other suitable pooling functions. A pooling function (e.g., a max-pooling filter, an L2-norm filter, or other suitable pooling filter) is applied to each activation map included in the convolutional hidden layer 604. In the example shown in FIG. 6, three pooling filters are used for the three activation maps in the convolutional hidden layer 604.

In some examples, max-pooling can be used by applying a max-pooling filter (e.g., having a size of 2×2) with a stride (e.g., equal to a dimension of the filter, such as a stride of 2) to an activation map output from the convolutional hidden layer 604. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 604 having a dimension of 24×24 nodes, the output from the pooling hidden layer 606 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 600.

The final layer of connections in the network is a fully-connected layer that connects every node from the pooling hidden layer 606 to every one of the output nodes in the output layer 610. Using the example above, the input layer includes 28×28 nodes encoding the pixel intensities of the input image, the convolutional hidden layer 604 includes 3×24×24 hidden feature nodes based on application of a 5×5 local receptive field (for the filters) to three activation maps, and the pooling hidden layer 606 includes a layer of 3×12×12 hidden feature nodes based on application of max-pooling filter to 2×2 regions across each of the three feature maps. Extending this example, the output layer 610 can include ten output nodes. In such an example, every node of the 3×12×12 pooling hidden layer 606 is connected to every node of the output layer 610.

The fully connected layer 608 can obtain the output of the previous pooling hidden layer 606 (which should represent the activation maps of high-level features) and determines the features that most correlate to a particular class. For example, the fully connected layer 608 can determine the high-level features that most strongly correlate to a particular class and can include weights (nodes) for the high-level features. A product can be computed between the weights of the fully connected layer 608 and the pooling hidden layer 606 to obtain probabilities for the different classes. For example, if the CNN 600 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 610 can include an M-dimensional vector (in the prior example, M=10). M indicates the number of classes that the CNN 600 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

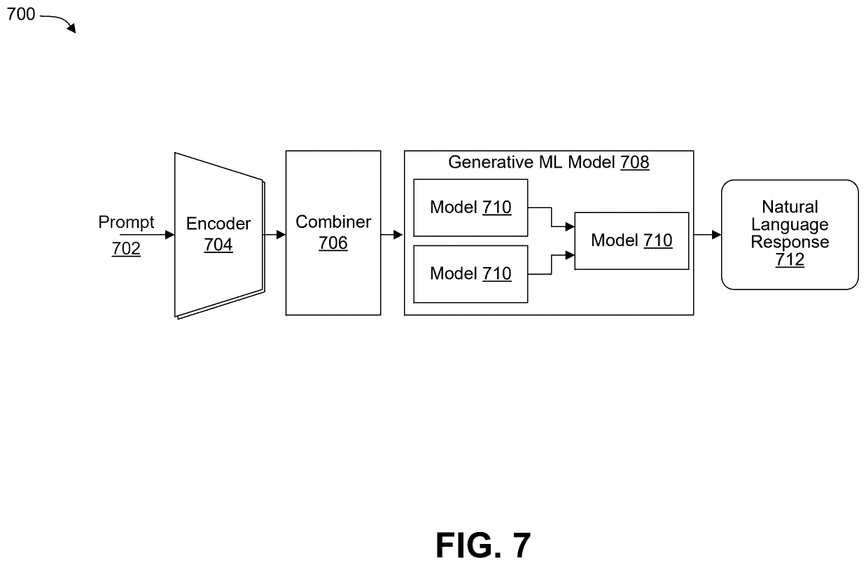

FIG. 7 is a block diagram illustrating a multimodal generative machine-learning (ML) system 700 for generating natural language responses based on natural language input from a prompt 702 and any additional information. A multimodal machine learning system is a machine learning model that receives, processes, and outputs data in multiple forms. For example, the input prompt may include text, images, and audio. LMM 108 may be an example of multimodal generative ML system 700.

For example, the multimodal generative ML system 700 includes a plurality of encoders 704 that are each configured to encode different modes of content (e.g., text, images, audio, etc.) into different tokens within a common embedding space. For example, a text input may be segmented based on different techniques (e.g., paragraph, sentence, etc.) and encoded by a text encoder (from the encoders 704) into tokens. In another example, one or more images can be provided to an image encoder (from the encoders 704) that extracts features associated with the image and generates tokens representing the visual features. In another example, audio can be provided to an audio encoder (from the encoders 704) that extracts features associated with the image and generates tokens representing the audio features. In the case of audio, the audio encoder can identify features that can include formants that characterize resonant frequencies in speech, rhythmic features related to timing and tempo, and harmonic features that describe the relationship between fundamental frequencies and their harmonics.

The different tokens from the plurality of encoders are provided to combiner 706. The combiner 706 can combine the tokens based on the order in which they are presented. For example, the input into the encoder may be an array of primitive values. A primitive value is an immutable data type provided by a programming language and includes values that represent a single piece of data (e.g., number, string, Boolean, etc.) rather than a complex object or reference. A non-limiting example prompt may include a byte array (e.g., an unsigned 8-byte integer array or unit 8 array), and another string. The byte array may be audio, images, or other content that can be processed by the encoders 704. In some aspects, the combiner 706 is configured to concatenate the different tokens in order based on the array to preserve the semantic order of features and provide the tokens to the generative machine learning model 708.

The generative machine learning model 708 is configured to receive the tokens and generate a natural language response 712 based on the tokens and the prompt 702. Generative machine learning model 708 may include one or more models 710 (e.g., transformer neural network(s), diffusion model(s), fully connected layer(s), multilayer perceptrons (MLPs), any combination thereof, and/or other models). The one or more models 710 of the generative machine learning model 708 are configured to process the tokens and extract different types of features that are relevant to the prompt 702. For example, the prompt 702 can be a query for a particular type of information. The one or more models of the generative machine learning model 708 can perform different tasks related to the query, such as writing code to perform a particular function, generating an image based on an input image with expressed modifications, generate an image without any input image, and so forth.

The generative machine learning model 708 may include different components, such as a featurization engine to identify different types of features, an inference engine to identify inferences within the text (e.g., pronoun usage and corresponding disambiguation functions), data retrieval engines (e.g., to identify features related to a particular concept observed by the generative machine learning model 708), and so forth. The generative machine learning model 708 may also include different types of models and engines to synthesize a coherent contextual output, such as to synthesize the input content and information that is responsive to tasks embedded within the text. For example, the generative machine learning model 708 may include a predictive output engine (not shown) that is configured to generate a sequence of words that is most likely contextually correct and to provide a coherent and contextually relevant answer. For instance, the predictive output generation engine can generate responses by sampling from the probability distribution of possible words and sequences based on patterns observed during training. The generative machine learning model 708 may also include a predictive output generation engine to generate multiple responses that are potentially relevant and coherent with respect to the prompt 702. The generative machine learning model 708 may also include an output validation engine configured to evaluate the generated responses based on certain criteria. Non-limiting examples of criteria to evaluate generated responses include relevance to the prompt, coherence, fluency, and adherence to specific guidelines or rules. Based on the evaluation, the output validation engine may select and output the most appropriate response.

As noted above, the generative machine learning model 708 may include various types of models (e.g., machine learning models), such as a transformer. A transformer is a neural network architecture that can be trained to perform one or more natural language processing (NLP) tasks, such as language translation, sentiment analysis, and text summarization. Conventional traditional recurrent neural networks (RNNs) process data in sequence. A transformer or transformer network can process input in parallel and can thus be faster and more efficient than sequential training and processing. In some aspects, a transformer can use a self-attention mechanism (e.g., one or more self-attention layers), which allows the transformer to identify the most relevant parts of the input text or content (e.g., audio or video). In some cases, a transformer can also use a cross-attention mechanism (e.g., one or more cross-attention layers) which uses other content or data to determine the most relevant parts of the input. For example, cross-attention mechanisms are useful in sequential content such as a stream of data, such as optical flow, and other computer vision techniques.

A transformer neural network can include a multi-layer encoder-decoder architecture. For instance, an encoder of the encoder-decoder architecture can receive text as input, convert the input text into a sequence of hidden representations, and capture the meaning of the text at different levels of abstraction. A decoder of the encoder-decoder architecture can then process the representations output from the decoder to generate an output sequence, such as a text translation or a summary. The encoder and decoder can be trained together using supervised learning, unsupervised learning, or a combination of supervised and unsupervised learning techniques, such as maximum likelihood estimation and self-supervised pretraining. Illustrative examples of transformer engines include a BERT model, a Text-to-Text Transfer Transformer (T5), biomedical BERT (BioBERT), scientific BERT (SciBERT), and the SPECTER model for document-level representation learning. In some aspects, multiple transformer engines may be used to generate different tokens.

In some aspects, the generative machine learning model 708 may be executed using a neural engine (or multiple neural engines) for on-device execution, such as a neural processing unit (NPU), a neural signal processor (NSP), a digital signal processor (DSP), any combination thereof, and/or other neural engine. The neural engine can include a plurality of neural processing cores that are configured to parallelize operations associated with neural networks. A neural processing core can include arrays of multiply-accumulate (MAC) units and specialized instructions that are optimized for matrix operations, such as convolution and matrix multiplication. The neural processing core can receive input data and perform matrix transformations and nonlinear activation functions to break down and parallelize matrix operations. The neural processing core can perform tasks such as inference (e.g., runtime operation of a machine learning model) or training of deep learning models. The neural processing core can accelerate tasks by parallelization of larger computations that can be performed in parallel (e.g., matrix operations associated with neural networks). For instance, the neural engine may perform computer vision tasks such as object recognition. In some cases, the neural engine can be implemented based on various ML libraries such as PyTorch, which interfaces with the compute unified device architecture (CUDA) to parallelize operations.

In some aspects, the generative machine learning model 708 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters that results in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because the information is not transmitted over the network and only relies on information requested by the user or usage at the local device.

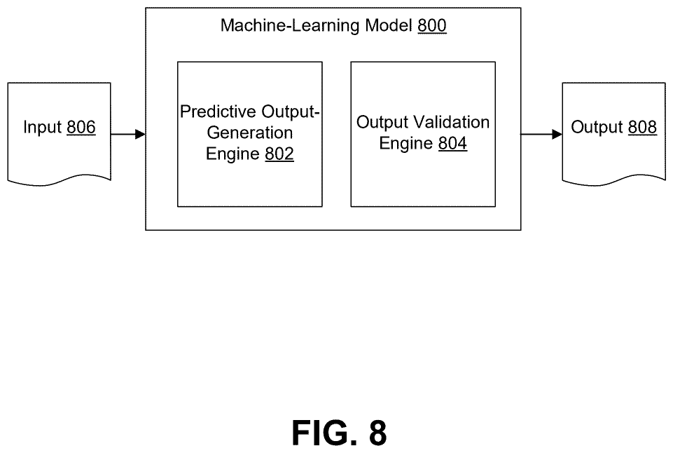

FIG. 8 includes an example machine-learning model 800 that may be used in various aspects of the present disclosure. For example, LMM 108 may be an example of machine-learning model 800.

Machine-learning model 800 is an example of a generative response engine. Generative response engines are commonly referred to as Generative AI. Generative response engines can receive an input prompt (e.g., input 806) and generate content (e.g., output 808) based on the prompt. Generative Pre-trained Transformers (GPTs), diffusion models, and diffusion-transformer models are some non-limiting examples of generative response engines.

Machine-learning model 800 includes a predictive output-generation engine 802 and Output validation engine 804. Predictive output-generation engine 802 may analyze input 806 and identify relevant patterns and associations based on data on which predictive output-generation engine 802 was trained. Further, predictive output-generation engine 802 may predict a sequence of words that are the most likely continuation of input 806. By iteratively predicting next words, predictive output-generation engine 802 may aim to provide a coherent and contextually relevant answer to input 806. Predictive output-generation engine 802 may generate responses by sampling from the probability distribution of possible words and sequences, guided by the patterns observed during the training of predictive output-generation engine 802. In some aspects, predictive output-generation engine 802 may generate multiple possible responses before outputting a final one. The multiple responses may be variations that predictive output-generation engine 802 considers potentially relevant and coherent. Output validation engine 804 may evaluate the multiple generated responses based on certain criteria. These criteria can include relevance to the prompt, coherence, fluency, and sometimes adherence to specific guidelines or rules, depending on the application. Based on this evaluation, output validation engine 804 may select a most appropriate response. This selection is typically the one that scores highest on the set criteria, balancing factors like relevance, informativeness, and coherence.

Input 806 and/or output 808 may be, or may include, text, image data, video data, numerical data, etc. For example, machine-learning model 800 may perform tasks such as, text summarization, text translation, text generation, responding to queries, image description, video description, image generation (e.g., based on text and/or image data), video generation (e.g., based on text and/or image data), image rendering (e.g., based on a 3D model and/or image data), object detection (e.g., based on image data and/or video data) etc. As such, machine-learning model 800 may be referred to as a large language model (LLM), a vision-language model (VLM), a multilingual language model (MLLM) a large vision model (LVM), etc.

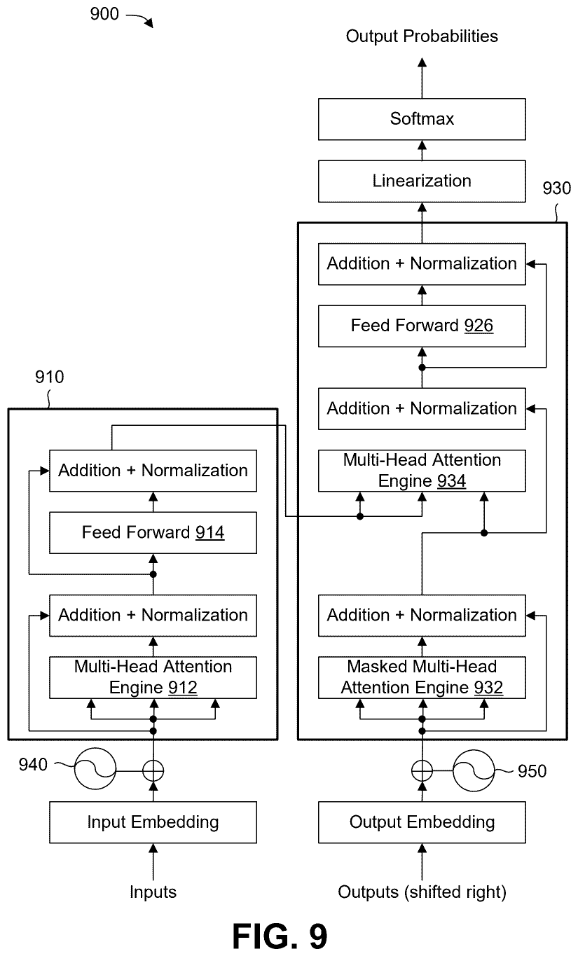

FIG. 9 is a block diagram of an example transformer 900 in accordance with some aspects of the disclosure. Additionally, transformer 900 may be included in multimodal generative ML system 700 and/or machine-learning model 800.

In a convolutional neural network (CNN) model, the number of operations required to relate signals from two arbitrary input or output positions grows in the distance between positions, which makes learning dependencies at different distant positions challenging for a CNN model. A transformer 900 reduces the operations of learning dependencies by using an encoder 910 and a decoder 930 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 910 is composed of a stack of six identical layers and each layer has two sub-layers. The first sub-layer is a multi-head self-attention engine 912, and the second sub-layer is a fully-connected feed-forward network 914. A residual connection (not shown) connects around each of the sub-layers followed by normalization.

In this example transformer 900, the decoder 930 is also composed of a stack of six 6 identical layers. The decoder also includes a masked multi-head self-attention engine 932, a multi-head attention engine 934 over the output of the encoder 910, and a fully-connected feed-forward network 926. Each layer includes a residual connection (not shown) around the layer, which is followed by layer normalization. The masked multi-head self-attention engine 932 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 940 to encode positions because the model does not contain recurrence and convolution and relative or absolute position of the tokens is needed. In the transformer 900, the positional encodings are added to the input embeddings at the bottom layer of the encoder 910 and the decoder 930. The positional encodings are summed with the embeddings because the positional encodings and embeddings have the same dimensions. A corresponding position decoder 950 is configured to decode the positions of the embeddings for the decoder 930.

In some aspects, the transformer 900 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 900 can process input sequences of variable length, making it well-suited for natural language processing tasks where input lengths can vary greatly. Additionally, the self-attention mechanism allows the transformer 900 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 10 illustrates an example computing-device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1000 may include, implement, or be included in any or all of system 100 of FIG. 1, visual-token selector 104 of FIG. 1, system 300 of FIG. 3 and/or other devices, modules, or systems described herein. Additionally or alternatively, computing-device architecture 1000 may be configured to perform process 400, and/or other process described herein.

The components of computing-device architecture 1000 are shown in electrical communication with each other using connection 1012, such as a bus. The example computing-device architecture 1000 includes a processing unit (CPU or processor) 1002 and computing device connection 1012 that couples various computing device components including computing device memory 1010, such as read only memory (ROM) 1008 and random-access memory (RAM) 1006, to processor 1002.

Computing-device architecture 1000 can include a cache of high-speed memory connected directly with, in close proximity to, or integrated as part of processor 1002. Computing-device architecture 1000 can copy data from memory 1010 and/or the storage device 1014 to cache 1004 for quick access by processor 1002. In this way, the cache can provide a performance boost that avoids processor 1002 delays while waiting for data. These and other modules can control or be configured to control processor 1002 to perform various actions. Other computing device memory 1010 may be available for use as well. Memory 1010 can include multiple different types of memory with different performance characteristics. Processor 1002 can include any general-purpose processor and a hardware or software service, such as service 1 1016, service 2 1018, and service 3 1020 stored in storage device 1014, configured to control processor 1002 as well as a special-purpose processor where software instructions are incorporated into the processor design. Processor 1002 may be a self-contained system, containing multiple cores or processors, a bus, memory controller, cache, etc. A multi-core processor may be symmetric or asymmetric.

To enable user interaction with the computing-device architecture 1000, input device 1022 can represent any number of input mechanisms, such as a microphone for speech, a touch-sensitive screen for gesture or graphical input, keyboard, mouse, motion input, speech and so forth. Output device 1024 can also be one or more of a number of output mechanisms known to those of skill in the art, such as a display, projector, television, speaker device, etc. In some instances, multimodal computing devices can enable a user to provide multiple types of input to communicate with computing-device architecture 1000. Communication interface 1026 can generally govern and manage the user input and computing device output. There is no restriction on operating on any particular hardware arrangement and therefore the basic features here may easily be substituted for improved hardware or firmware arrangements as they are developed.

Storage device 1014 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1006, read only memory (ROM) 1008, and hybrids thereof. Storage device 1014 can include services 1016, 1018, and 1020 for controlling processor 1002. Other hardware or software modules are contemplated. Storage device 1014 can be connected to the computing device connection 1012. In one aspect, a hardware module that performs a particular function can include the software component stored in a computer-readable medium in connection with the necessary hardware components, such as processor 1002, connection 1012, output device 1024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“?”) and greater than or equal to (“?”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing data, the apparatus comprising: at least one memory; and at least one processor coupled to the at least one memory and configured to: process video data to generate a first plurality of visual tokens; process the first plurality of visual tokens to generate a first text, wherein the first text is descriptive of the video data; process a frame of the video data to generate a second plurality of visual tokens; process the second plurality of visual tokens to generate a second text, wherein the second text is descriptive of the frame of the video data; determine to process zero or more visual tokens selected from among the second plurality of visual tokens based on a similarity between the first text and the second text; and process the first plurality of visual tokens and zero or more visual tokens selected from among the second plurality of visual tokens using a machine-learning model.

Aspect 2. The method of aspect 1, wherein the at least one processor is configured to select the zero or more visual tokens from among the second plurality of visual tokens based on a similarity between the first text and the second text.

Aspect 3. The method of any one of aspects 1 or 2, wherein the similarity between the first text and the second text comprises a perplexity score based on the first text and the second text.

Aspect 4. The method of any one of aspects 1 to 3, wherein, in response to the similarity between the first text and the second text not exceeding a threshold, the at least one processor is configured to process the first plurality of visual tokens and zero visual tokens from among the second plurality of visual tokens using the machine-learning model.

Aspect 5. The method of any one of aspects 1 to 4, wherein the frame of the video data comprises a first frame of the video data, wherein the at least one processor is further configured to: process a second frame of the video data to generate a third plurality of visual tokens; process the third plurality of visual tokens to generate a third text; and determine to process zero or more visual tokens selected from among the third plurality of visual tokens based on a similarity between the first text and the third text, wherein, to process the first plurality of visual tokens and zero or more visual tokens selected from among the second plurality of visual tokens using the machine-learning model, the at least one processor is configured to process the first plurality of visual tokens, zero or more visual tokens selected from among the second plurality of visual tokens, and zero or more visual tokens selected from among the third plurality of visual tokens using the machine-learning model.

Aspect 6. The method of any one of aspects 1 to 5, wherein the machine-learning model comprises a large multi-modal model configured to generate an output based on visual tokens.

Aspect 7. The method of any one of aspects 1 to 6, wherein: to process the video data to generate the first plurality of visual tokens, the at least one processor is configured to process the video data using a video-encoder machine-learning model to generate the first plurality of visual tokens; and to process the frame of the video data to generate the second plurality of visual tokens, the at least one processor is configured to process the frame of the video data using an image-encoder machine-learning model to generate the second plurality of visual tokens.

Aspect 8. The method of any one of aspects 1 to 7, wherein: to process the first plurality of visual tokens to generate the first text, the at least one processor is configured to process the first plurality of visual tokens to using a video-captioning model to generate the first text; and to process the second plurality of visual tokens to generate the second text, the at least one processor is configured to process the second plurality of visual tokens to using an image-captioning model to generate the second text.

Aspect 9. A method for processing data, the method comprising: processing video data to generate a first plurality of visual tokens; processing the first plurality of visual tokens to generate a first text, wherein the first text is descriptive of the video data; processing a frame of the video data to generate a second plurality of visual tokens; processing the second plurality of visual tokens to generate a second text, wherein the second text is descriptive of the frame of the video data; determining to process zero or more visual tokens selected from among the second plurality of visual tokens based on a similarity between the first text and the second text; and processing the first plurality of visual tokens and zero or more visual tokens selected from among the second plurality of visual tokens using a machine-learning model.

Aspect 10. The method of aspect 9, further comprising selecting the zero or more visual tokens from among the second plurality of visual tokens based on a similarity between the first text and the second text.

Aspect 11. The method of any one of aspects 9 or 10, wherein the similarity between the first text and the second text comprises a perplexity score based on the first text and the second text.

Aspect 12. The method of any one of aspects 9 to 11, further comprising, in response to the similarity between the first text and the second text not exceeding a threshold, processing the first plurality of visual tokens and zero visual tokens from among the second plurality of visual tokens using the machine-learning model.

Aspect 13. The method of any one of aspects 9 to 12, wherein the frame of the video data comprises a first frame of the video data, the method further comprising: processing a second frame of the video data to generate a third plurality of visual tokens; processing the third plurality of visual tokens to generate a third text; and determining to process zero or more visual tokens selected from among the third plurality of visual tokens based on a similarity between the first text and the third text, wherein processing the first plurality of visual tokens and zero or more visual tokens selected from among the second plurality of visual tokens using the machine-learning model comprises processing the first plurality of visual tokens, zero or more visual tokens selected from among the second plurality of visual tokens, and zero or more visual tokens selected from among the third plurality of visual tokens using the machine-learning model.

Aspect 14. The method of any one of aspects 9 to 13, wherein the machine-learning model comprises a large multi-modal model configured to generate an output based on visual tokens.

Aspect 15. The method of any one of aspects 9 to 14, wherein: processing the video data to generate the first plurality of visual tokens comprises processing the video data using a video-encoder machine-learning model to generate the first plurality of visual tokens; and processing the frame of the video data to generate the second plurality of visual tokens comprises processing the frame of the video data using an image-encoder machine-learning model to generate the second plurality of visual tokens.

Aspect 16. The method of any one of aspects 9 to 15, wherein: processing the first plurality of visual tokens to generate the first text comprises processing the first plurality of visual tokens to using a video-captioning model to generate the first text; and processing the second plurality of visual tokens to generate the second text comprises processing the second plurality of visual tokens to using an image-captioning model to generate the second text.

Aspect 17. A non-transitory computer-readable storage medium having stored thereon instructions that, when executed by at least one processor, cause the at least one processor to: process video data to generate a first plurality of visual tokens; process the first plurality of visual tokens to generate a first text, wherein the first text is descriptive of the video data; process a frame of the video data to generate a second plurality of visual tokens; process the second plurality of visual tokens to generate a second text, wherein the second text is descriptive of the frame of the video data; determine to process zero or more visual tokens selected from among the second plurality of visual tokens based on a similarity between the first text and the second text; and process the first plurality of visual tokens and zero or more visual tokens selected from among the second plurality of visual tokens using a machine-learning model.

Aspect 18. The non-transitory computer-readable storage medium of aspect 17, wherein the instructions, when executed by the at least one processor, cause the at least one processor to select the zero or more visual tokens from among the second plurality of visual tokens based on a similarity between the first text and the second text.

Aspect 19. The non-transitory computer-readable storage medium of any one of aspects 17 or 18, wherein the similarity between the first text and the second text comprises a perplexity score based on the first text and the second text.

Aspect 20. The non-transitory computer-readable storage medium of any one of aspects 17 to 19, wherein the instructions, when executed by the at least one processor, cause the at least one processor to, in response to the similarity between the first text and the second text not exceeding a threshold, process the first plurality of visual tokens and zero visual tokens from among the second plurality of visual tokens using the machine-learning model.

Aspect 21. A non-transitory computer-readable storage medium having stored thereon instructions that, when executed by at least one processor, cause the at least one processor to perform operations according to any of aspects 9 to 16.

Aspect 22. An apparatus for processing data, the apparatus comprising one or more means for perform operations according to any of aspects 9 to 16.

What is claimed is:

1. An apparatus for processing data, the apparatus comprising:
at least one memory; and
at least one processor coupled to the at least one memory and configured to:
process video data to generate a first plurality of visual tokens;
process the first plurality of visual tokens to generate a first text, wherein the first text is descriptive of the video data;
process a frame of the video data to generate a second plurality of visual tokens;
process the second plurality of visual tokens to generate a second text, wherein the second text is descriptive of the frame of the video data;
determine to process zero or more visual tokens selected from among the second plurality of visual tokens based on a similarity between the first text and the second text; and
process the first plurality of visual tokens and zero or more visual tokens selected from among the second plurality of visual tokens using a machine-learning model.

2. The apparatus of claim 1, wherein the at least one processor is configured to select the zero or more visual tokens from among the second plurality of visual tokens based on a similarity between the first text and the second text.

3. The apparatus of claim 1, wherein the similarity between the first text and the second text comprises a perplexity score based on the first text and the second text.

4. The apparatus of claim 1, wherein, in response to the similarity between the first text and the second text not exceeding a threshold, the at least one processor is configured to process the first plurality of visual tokens and zero visual tokens from among the second plurality of visual tokens using the machine-learning model.

5. The apparatus of claim 1, wherein the frame of the video data comprises a first frame of the video data, wherein the at least one processor is further configured to:
process a second frame of the video data to generate a third plurality of visual tokens;
process the third plurality of visual tokens to generate a third text; and
determine to process zero or more visual tokens selected from among the third plurality of visual tokens based on a similarity between the first text and the third text,
wherein, to process the first plurality of visual tokens and zero or more visual tokens selected from among the second plurality of visual tokens using the machine-learning model, the at least one processor is configured to process the first plurality of visual tokens, zero or more visual tokens selected from among the second plurality of visual tokens, and zero or more visual tokens selected from among the third plurality of visual tokens using the machine-learning model.

6. The apparatus of claim 1, wherein the machine-learning model comprises a large multi-modal model configured to generate an output based on visual tokens.

7. The apparatus of claim 1, wherein:
to process the video data to generate the first plurality of visual tokens, the at least one processor is configured to process the video data using a video-encoder machine-learning model to generate the first plurality of visual tokens; and
to process the frame of the video data to generate the second plurality of visual tokens, the at least one processor is configured to process the frame of the video data using an image-encoder machine-learning model to generate the second plurality of visual tokens.

8. The apparatus of claim 1, wherein:
to process the first plurality of visual tokens to generate the first text, the at least one processor is configured to process the first plurality of visual tokens to using a video-captioning model to generate the first text; and
to process the second plurality of visual tokens to generate the second text, the at least one processor is configured to process the second plurality of visual tokens to using an image-captioning model to generate the second text.

9. A method for processing data, the method comprising:
processing video data to generate a first plurality of visual tokens;
processing the first plurality of visual tokens to generate a first text, wherein the first text is descriptive of the video data;
processing a frame of the video data to generate a second plurality of visual tokens;
processing the second plurality of visual tokens to generate a second text, wherein the second text is descriptive of the frame of the video data;
determining to process zero or more visual tokens selected from among the second plurality of visual tokens based on a similarity between the first text and the second text; and
processing the first plurality of visual tokens and zero or more visual tokens selected from among the second plurality of visual tokens using a machine-learning model.

10. The method of claim 9, further comprising selecting the zero or more visual tokens from among the second plurality of visual tokens based on a similarity between the first text and the second text.

11. The method of claim 9, wherein the similarity between the first text and the second text comprises a perplexity score based on the first text and the second text.

12. The method of claim 9, further comprising, in response to the similarity between the first text and the second text not exceeding a threshold, processing the first plurality of visual tokens and zero visual tokens from among the second plurality of visual tokens using the machine-learning model.

13. The method of claim 9, wherein the frame of the video data comprises a first frame of the video data, the method further comprising:
processing a second frame of the video data to generate a third plurality of visual tokens;
processing the third plurality of visual tokens to generate a third text; and
determining to process zero or more visual tokens selected from among the third plurality of visual tokens based on a similarity between the first text and the third text,
wherein processing the first plurality of visual tokens and zero or more visual tokens selected from among the second plurality of visual tokens using the machine-learning model comprises processing the first plurality of visual tokens, zero or more visual tokens selected from among the second plurality of visual tokens, and zero or more visual tokens selected from among the third plurality of visual tokens using the machine-learning model.

14. The method of claim 9, wherein the machine-learning model comprises a large multi-modal model configured to generate an output based on visual tokens.

15. The method of claim 9, wherein:
processing the video data to generate the first plurality of visual tokens comprises processing the video data using a video-encoder machine-learning model to generate the first plurality of visual tokens; and
processing the frame of the video data to generate the second plurality of visual tokens comprises processing the frame of the video data using an image-encoder machine-learning model to generate the second plurality of visual tokens.

16. The method of claim 9, wherein:
processing the first plurality of visual tokens to generate the first text comprises processing the first plurality of visual tokens to using a video-captioning model to generate the first text; and
processing the second plurality of visual tokens to generate the second text comprises processing the second plurality of visual tokens to using an image-captioning model to generate the second text.

17. A non-transitory computer-readable storage medium having stored thereon instructions that, when executed by at least one processor, cause the at least one processor to:
process video data to generate a first plurality of visual tokens;
process the first plurality of visual tokens to generate a first text, wherein the first text is descriptive of the video data;
process a frame of the video data to generate a second plurality of visual tokens;
process the second plurality of visual tokens to generate a second text, wherein the second text is descriptive of the frame of the video data;
determine to process zero or more visual tokens selected from among the second plurality of visual tokens based on a similarity between the first text and the second text; and
process the first plurality of visual tokens and zero or more visual tokens selected from among the second plurality of visual tokens using a machine-learning model.

18. The non-transitory computer-readable storage medium of claim 17, wherein the instructions, when executed by the at least one processor, cause the at least one processor to select the zero or more visual tokens from among the second plurality of visual tokens based on a similarity between the first text and the second text.

19. The non-transitory computer-readable storage medium of claim 17, wherein the similarity between the first text and the second text comprises a perplexity score based on the first text and the second text.

20. The non-transitory computer-readable storage medium of claim 17, wherein the instructions, when executed by the at least one processor, cause the at least one processor to, in response to the similarity between the first text and the second text not exceeding a threshold, process the first plurality of visual tokens and zero visual tokens from among the second plurality of visual tokens using the machine-learning model.
